(19) United States
(12) Patent Application Publication
(10) Pub. No.: US 2005/0157487 A1
(43) Pub. Date: Jul. 21, 2005

(54) Submersible light source for an optical fiber flower display in a water-filled vase

(76) Inventor: Kenneth R. Epstein, Burbank, CA (US)

Correspondence Address: William Propp. Esq., 8205 Santa Monica Blvd., PMB1-245, West Hollywood, CA, 90046, US

(21) Appl. No.: 10/759,883

(22) Filed: Jan. 16, 2004

(51) Int. Cl. F21V 33/00

(52) U.S. Cl. 362/101; 362/154; 362/562

(57) ABSTRACT

Optical fibers illuminate the flower display in a water-filled vase. The light source for the optical fibers is submerged in the water in the vase. The light source contains a battery, an on/off switch, a control circuit and at least one light emitting diode in a waterproof housing.

### BACKGROUND OF THE INVENTION

This invention relates generally to an optical fiber light source for a flower display and, more particularly, to a submersible optical fiber light source for a flower display in a water-filled vase.

A flower display in the vase can be illuminated by an external light source such as spotlights or area lights. This external lighting increases glare off the vase, the flowers and even the water in the vase. The distance between the external lighting and the flower display increases the scattering of reflected light from the flower display. And the brightness and color of the external lighting may overwhelm the natural coloring of the flowers on display in the vase.

Artificial flowers can be used in a flower display and the artificial flowers can emit light. A light-producing chemical is formed at the base of an artificial flower in U.S. Pat. No. 5,508,901. The light-producing chemical mix is drawn up colored tubes within the artificial flower by capillary action to fabric flower petals. The tubes and fabric flower petals emit light from the chemical.

However, this prior art device requires special artificial flowers and does not use commercially available artificial flowers, nor natural flowers.

The lighting for the flower display may come from within the vase. A vase may have an upper chamber and a lower chamber, according to U.S. Pat. Nos. 4,616,304; 5,547,721; and 6,352,352. The upper watertight chamber holds water and the flower. The lower dry chamber beneath the upper chamber holds a light source.

The two chambers are separated by a transparent or translucent layer. Light emitted from the light source in the lower chamber travels upward through the layer to illuminate the water and flowers in the upper chamber.

The light however illuminates the water and the underside of the flowers. And the prior art device requires a specially manufactured vase, rather than a commercially available vase.

The prior art does not provide illumination for commercially available artificial or natural flowers in a commercially available vase. The prior art does not provide illumination adjacent to or surrounding or amidst the flowers in a vase.

It is an object of the present invention to illuminate flowers in a vase.

It is another object of the present invention to illuminate commercially available artificial or natural flowers in a vase.

It is yet another object of the present invention to illuminate flowers in a commercially available vase.

It is still another object of the present invention to provide illumination to natural and artificial flowers in a vase with water.

It is still another object of the present invention to provide a light source in close proximity to flowers in a vase.

### SUMMARY OF THE INVENTION

According to the present invention, the light source for an optical fiber flower display consists of a power source such as a battery, a switch, any light control circuitry and at least one light emitting diode. The waterproof light source is submerged in the water of a vase next to the stem of the flower in the vase. Optical fibers run from the light source to the petals of the flower. Light flows from the light source through the optical fibers to illuminate the flower petals. The vase, the water and the flower stem help hide the light source from view.

The light emitting diode can emit colored light. A colored filter can be positioned between the light emitting diode and the optical fibers. The optical fibers can be colored. All three approaches will illuminate the flowers with colored light.

The light source can be a plurality of light emitting diodes. Each of the light emitting diodes can direct light to all of the optical fibers or the optical fibers can be divided into groups with each light emitting diode only directing light to one group of optical fibers.

The submerged waterproof light source can illuminate commercially available artificial or natural flowers in a commercially available vase.

Other aspects of the invention will become apparent from the following more detailed description, taken in conjunction with the accompanying drawings.

### BRIEF DESCRIPTION OF THE DRAWINGS

The preferred embodiments of this invention will be described in detail, with reference to the following figures wherein:

FIG. 1 is a side view of an optical fiber submerged light source for a flower display in a vase of the present invention.

FIG. 2 is a side view of the light source within the housing of the present invention.

FIG. 3 is a side partial view of the light source with a colored filter between the light emitting diode and the optical fibers within the housing of the present invention.

FIG. 4 is a side partial view of a multiple light emitting diode light source within the housing of the present invention.

### DETAILED DESCRIPTION OF THE INVENTION

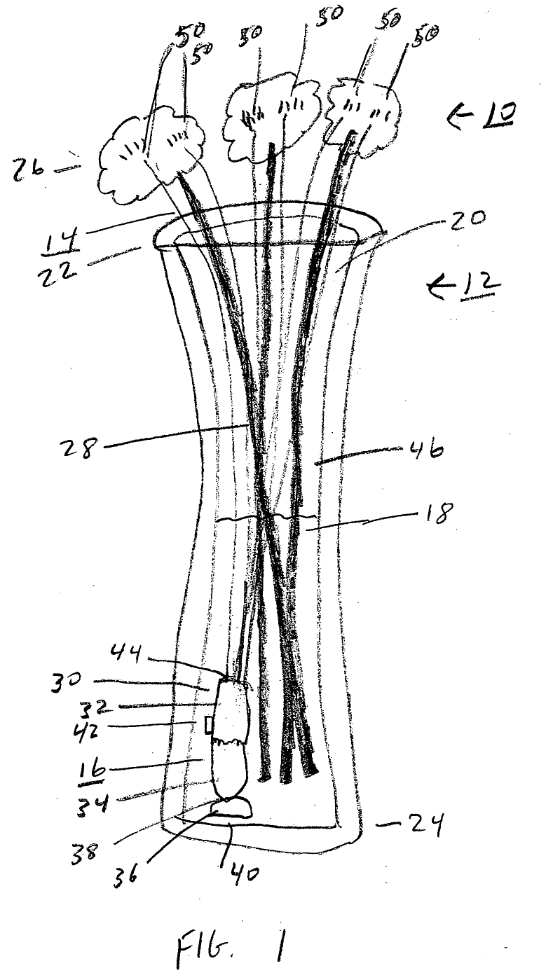

Reference is now made to FIG. 1 illustrating flowers 10 in a vase 12 with an optical fiber 14 light source 16 submerged in the water 18 in the vase of the present invention.

The vase 12 is shown as a traditional, conical, fluted style but may be of any design. In this present invention, the vase need not be transparent or translucent.

The vase 12 is a commercially available flower vase having an elongated hollow chamber 20 with an open end 22 and a closed end 24. Water 18 partially fills or fully fills the hollow chamber 20 of the vase 12 at the closed end 24. The chamber retains the water to hydrate the natural flowers and presents a pleasing visual environment for both the artificial and natural flowers.

The flowers 10 are commercially available artificial or natural flowers having individual petals 26 connected to individual stems 28.

The stems 28 of the flowers 10 are inserted through the open end 22 of the vase 12 into the chamber 20. The stems 28 will be in the water 18 of the chamber 20 closest to the closed end 24 of the vase 12 while the petals 26 will be outside the open end 22 of the vase 12.

The light source 16 has a generally cylindrical housing 30 with a closed end top body 32 and a closed end rear cap 34. The light source 16 is submerged under the water 18 in the vase 12 and adjacent to the stems 28 of the flowers 10. The housing is waterproof or, alternatively, the light source within the housing is not effected by water. The light source housing can be obscured from view by the stems of the flowers, the water and the vase.

A suction cup 36, affixed at the rear cap 34 to the outer surface 38 of the housing 30, can be semi-permanently or removably secured by the suction surface 40 to the closed end 24 of the chamber 20. The engagement of the suction cup 36 against the surface produces a vacuum bond such that the light source can be semi-permanently attached to any surface of the vase. Semi-permanent engagement will be maintained until the suction cup 36 of the light source is physically detached from the inner surface of the vase.

An on/off slide switch 42 is on the outer surface 38 of the housing 30.

Optical fibers 14 from the light source 16 extend from the closed end 44 of the housing body 32 adjacent to the stems 28 of the flowers 10 under water 18, along the stems 28 of the flowers 10 out of the water in the ambient atmosphere 46, through the open end 22 of the vase 12 to the petals 26 of the flowers 10. The proximal ends 48 of the optical fibers 14 are within the housing 30. The light source 16 will emit light through the proximal ends 48 of the optical fibers 14, which is transmitted through the optical fibers 14. The distal ends 50 of the optical fibers 14 are adjacent to and/or among the petals 26 of the flowers 10. The distal ends 50 of the optical fibers 14 will emit light to illuminate the petals 26 of the flowers 10.

This illumination can highlight or accent the flower display in the vase. The lighting effect created throughout such a flower display is much more uniform and attractive. The directional lighting from close proximity minimizes scattering of light, with attendant increased efficacy and power savings.

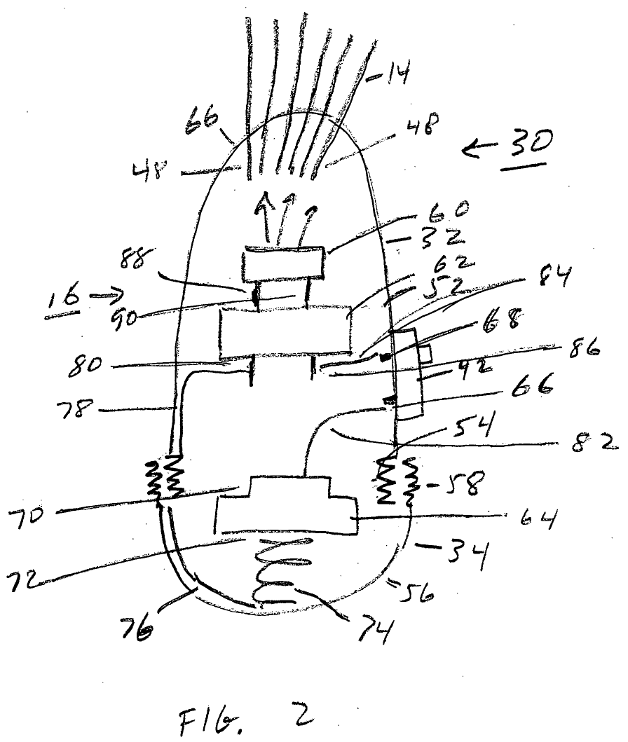

Referring now to FIG. 2, within the housing 30, the inner wall 52 of the bottom of the housing body 32 has circular threads 54. The outer wall 56 of the top of the housing rear cap 34 has circular threads 58 corresponding to the circular threads 54 of the housing body 32.

The cap 34 is to be connected to the body 32 so that the threads 54 and 58 engage. The housing top body 32 and the housing rear cap 34 are screwed together to establish a watertight seal to the housing 30. A rubber or silicone O-ring (not shown in the Figure) may be provided in either the circular threads 54 of the housing top body 32 or the circular threads 58 of the housing rear cap 34 to provide a further watertight seal.

The light source 16 within the housing consists of a light emitting diode (LED) 60, a light emitting diode control circuit 62, the interior portion of the on/off switch 42, and at least one battery 64 as a power source.

The optical fibers 14 extend through the closed end 66 of the housing body 32 into the housing 30. The light emitting diode 60 is positioned adjacent to the proximal ends 48 of the optical fibers 14 within the housing body 32. Light emitted by the light emitting diode 60 is directed to the proximal ends 48 to be transmitted through the optical fibers 14 to be emitted by the distal ends to illuminate the flowers in the display.

Typically, the proximal ends 48 of the optical fibers 14 will be positioned at or near the focal point of the light emitting diode 60 to maximize illumination.

The light emitting diode control circuit 62 is positioned adjacent to the light emitting diode 60 within the housing body 32.

The on/off switch 42 is mounted on the outside surface of the housing 30 with the switch electrical contacts 66, 68 positioned on the inside wall 52 of the housing body 32.

The battery 64 is inserted into the rear cap 34 of the housing 30 with the positive terminal 70 towards the housing body 32 and the negative terminal 72 towards the rear cap 34. The negative terminal 70 of the battery 64 abuts against a spring 74 fixedly mounted within the rear cap 34. The spring 64 controls battery 64 contact with the light emitting diode 60, the light emitting diode control circuit 62, and the switch 42.

The negative terminal 70 of the battery 64 is electrically and physically connected to the spring 74. The spring 74 is electrically and physically connected to the first electrical strip 76 which runs along the internal wall 56 of the rear cap 34 to the rear cap threads 58. This provides the ground conductor.

The rear cap threads 58 are electrically and physically connected to the body threads 54.

The first electrical strip 76 is electrically and physically connected to the second electrical strip 78 which runs along the internal wall 52 of the housing body 32 to the first contact 80 of the LED control circuit 62.

The positive terminal 70 of the battery 64 is electrically and physically connected to the third electrical strip 82 which runs along the internal wall 52 of the housing body 32 to the first contact 66 of the switch 42. The spring 74 exerts a continuous bias against the battery 64 to maintain that connection.

The second contact 66 of the switch 42 is electrically and physically connected to the fourth electrical contact strip 84 which runs along the internal wall 52 of the housing body 32 to the second contact 86 of the LED control circuit 62.

The first and second contacts 88, 90 of the LED 60 are electrically and physically connected to the LED control circuit 62.

The external slide switch 42 when moved will activate and deactivate the light source 16.

With the switch 42 in the on position, the electrical circuit is completed for the battery 64 to provide power to the LED 60 for light emission. The emitted light exits the light source 16 housing through the optical fibers 14 to illuminate the flowers in the display in the case.

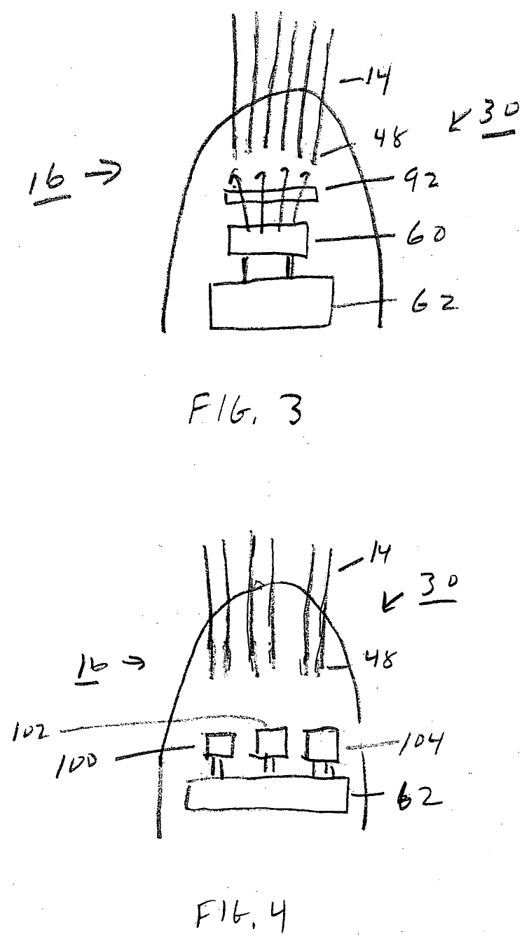

As seen in FIG. 3, a colored filter 92 can be positioned between the light emitting diode 60 and the proximal ends 48 of the optical fibers 14 to color the emitted light from the light emitting diode to the proximal ends to provide colored light illumination of the flower display by the distal ends of the optical fibers.

A lens or series of lens (not shown) can be positioned between the light emitting diode 60 and the proximal ends 48 of the optical fibers 14 to direct or focus the emitted light from the light emitting diode on the proximal ends to maximize illumination.

The light emitting diode 60 can emit colored light, which is transmitted by the optical fibers 14 to illuminate the flower display with colored light. Alternately, the optical fibers 14 can be colored to illuminate the flower display with colored light. Again alternately, with multiple optical fibers 14, each optical fiber or group of optical fibers can be different colored to illuminate the flower display with multiple colored light.

The optical fibers 14 can have different lengths or can be colored to emit different colored light from the light emitted by the LED. The optical fibers 14 can emit light along their length or along predetermined sections of the their length. The optical fibers 14 can have different thicknesses to vary the intensity of the illumination at the distal ends adjacent to or among the flower display.

The optical fibers' length, thickness, coloring and emission along the length can be tailored for different flower displays.

The on/off switch 42 of the light source 16 can be momentary, push button, pressure sensitive, rotating, rotating momentary, variable resistance switches consisting of rotating, pressure sensitive, or momentary rotating.

A switch is not necessary for the present invention. In one embodiment of the present invention, movement of the housing body 32 relative to the rear cap 34 completes the electrical circuit and causes light emission from the LED 60 through the optical fibers 14 to illuminate the flower display. Without a switch, the third electrical strip 82 is connected physically and electrically to the fourth electrical strip 84. The positive terminal 70 of the battery 64 will thus be connected directly to the second contact 86 of the LED control circuit 62.

To stop the flow of current to the light emitting diode, the rear cap 34 may be rotated relative to the housing body 32, which causes it to unscrew and release the compression on the spring 74 thereby breaking the contact and the circuit between the battery 64 and the light emitting diode 60.

The LED control circuit 62 can be a simple blinker circuit with a specified or variable repetition rate and a specified or variable duty cycle to turn the LED 60 on and off to illuminate the flower display. The LED control circuit 62 can also set or vary the intensity of the light emitted by the LED 60 and consequentially set or vary the intensity of the light illuminated the flower display through the optical fibers 14. The LED control circuit 62 can provide other more complex light patterns for the LED 60 and the illumination of the flower display through the optical fibers 14. The LED control circuit 62 may be integral with the light emitting diode 60 as a module.

A control circuit is not necessary for the present invention. The switch 42 provides a simple on/off pattern for the optical fiber 14 light source 16 to illuminate the flower display. Without a control circuit, the first and second electrical circuit strips 76, 78 from the negative terminal 72 of the battery 64 and the first contact 88 of the LED 60 can be connected directly, electrically and physically. The fourth circuit strip 84 from the switch 42 and the second contact 90 of the LED 60 can be connected directly, electrically and physically.

The light source of the present invention may also be lasers or light bulbs with the requisite intensity to illuminate the flower display by light emission and transmission through the optical fibers.

The optical fibers can be removed and replaced from the housing and flower display with similar or different optical fibers.

The control circuit can be removed and replaced with similar pre-programmed light patterns or different pre-programmed light patterns for the LED emission and optical fiber transmission for flower display illumination.

The battery or batteries can be removed and replaced as the power source for the light source to adjust for the current requirements for different removed and replaced LEDs, different removed and replaced control circuits, or light transmission through different removed and replaced optical fibers.

The spring can be removed and replaced to compensate for varying thicknesses of other replaced or removed components of LEDs, LED control circuits and batteries.

The housing may be a sealed unit with the rear cap sealed to the housing body with a friction fit, sealed with adhesive, ultrasonically sealed, heat sealed, or mechanically sealed.

The present invention encompasses not only an electronic control circuit to pattern the illumination of the flower display but also mechanic devices, run by motors or clockwork mechanism, such as rotating color filters or rotating transmissive/nontransmissive filters between the LED and the optical fibers in the light source housing.

The suction cup may be replaced by weights in the rear cup below or near the spring to counteract any buoyancy of the housing and position the housing at the closed end of the chamber of the vase. Alternately, the housing may be secured to the vase by water-resistant glue or partially or fully covered by sand, stones or marbles in the closed end of the chamber of the vase.

As seen in FIG. 4, the light source 16 of the present invention can have a plurality of LEDs 100, 102 and 104. In this illustrative example, the light source 16 is a green LED 100, a red LED 102 and a blue LED 104.

In the first embodiment with multiple LEDs, each of the proximal ends 48 of the optical fibers 14 will be positioned at or near the focal point of every light emitting diode 100, 102 and 104 to maximize illumination.

The control circuit 62 will selectively activate one of the three LEDs. That LED will emit light of that color directed to all the proximal ends of the optical fibers. Accordingly that colored light will be transmitted along the optical fibers to the distal ends to illuminate the flower display with that colored light. The red LED 100 will illuminate the flowers with red light, the green LED 102 with green light, the blue LED 104 with blue light. The colored illumination and pattern of colored illuminations will be controlled by the LED control circuit and will vary as the different LEDs emit light at different times.

Alternately, two LEDs can emit two different colored lights at the same time to combine to produce light of a different third color to be transmitted along the optical fibers to the distal ends to illuminate the flower display with different colored lights. Three LEDs can emit three different colored lights at the same time to produce light of a fourth color.

The intensities of the colored lights can also be varied by the control circuit controlling the current to each LED.

In the second embodiment with multiple LEDs, the proximal ends 48 of the optical fibers 14 are physically (based on relative positioning of the LED and optical fibers or with light absorbing material between the optical fibers) or optically (based on the focal point of the LED and optical fibers) divided into groups of optical fibers with one or more optical fibers in each group. Each different LED 100, 102, and 104 will emit different colored light to only one group of optical fibers. Each of the proximal ends of the optical fibers will be positioned at or near the focal point of only one light emitting diode.

The control circuit 62 will selectively activate one or more of the three LEDs. That LED will emit light of that color directed to the corresponding proximal ends of the optical fibers in that group. Accordingly that colored light will be transmitted along the optical fibers of that group to the distal ends of that group to partially illuminate the flower display with that colored light.

The red LED 100 will partially illuminate the flowers with red light, the green LED 102 will partially illuminate the flowers with green light, and the blue LED 104 will partially illuminate the flowers with blue light. Only the distal ends of the optical fibers whose proximal ends received light from that specific LED will illuminate the flowers. The other optical fibers will not emit light.

The colored illumination and pattern of colored illuminations will be controlled by the LED control circuit and will vary as the different LEDs emit light at the same time or at different times.

The control circuit with a plurality of different colored LEDs can produce different, more complex light patterns for the distal ends of the optical fibers to illuminate the flower display.

Again alternately, combining the first and second embodiments with multiple LEDs, some optical fibers can be exclusive to one colored LED while other optical fibers can overlap to two or more LEDs emission zones.

The light source may be submerged in the water in the vase. The light source may be partially submerged in the water in the vase and partially located in the ambient atmosphere in the vase above the water level. The light source may be totally in the ambient atmosphere in the vase above the water level. The light source may be in a dry vase.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

1. An optical fiber light source for a flower display in a vase comprising:
a vase having an open end and a closed end, said closed end forming a chamber for retaining water in said vase;
at least one flower at least partially in said chamber of said vase, said at least one flower having petals and a stem, said stem being in said water in said chamber in said vase;
a waterproof housing submerged in said water in said chamber in said vase having
a power source;
a light source driven by said power source to emit light; and
at least one optical fiber extending from said housing to adjacent to or among said petals of said at least one flower, said at least one optical fiber having a distal end and a proximal end, said proximal end receiving light emitted by said light source, said optical fiber transmitting said light and said distal end emitting said light to illuminate said at least one flower.

2. The optical fiber light source for a flower display in a vase of claim 1 wherein said light source is at least one light emitting diode.

3. The optical fiber light source for a flower display in a vase of claim 1 further comprising:
a switch to turn said light source off and on.

4. The optical fiber light source for a flower display in a vase of claim 1 further comprising:
a control circuit for said light source to pattern the emission of said light from said light source and the illumination of said at least one flower.

5. The optical fiber light source for a flower display in a vase of claim 1 further comprising:
a switch to turn said light source off and on; and
wherein said light source is at least one light emitting diode.

6. The optical fiber light source for a flower display in a vase of claim 1 further comprising:
a switch to turn said light source off and on;
a control circuit for said light source to pattern the emission of said light from said light source and the illumination of said at least one flower; and
wherein said light source is at least one light emitting diode.

7. The optical fiber light source for a flower display in a vase of claim 1 wherein said light source is a laser or a light bulb.

8. The optical fiber light source for a flower display in a vase of claim 1 wherein said light source is a plurality of light emitting diodes.

9. The optical fiber light source for a flower display in a vase of claim 8 wherein said at least one optical fiber is a plurality of optical fibers and each of said plurality of light emitting diodes emits light to be received by all of said plurality of optical fibers.

10. The optical fiber light source for a flower display in a vase of claim 8 wherein said at least one optical fiber is a plurality of optical fibers divided into different groups of optical fibers and each of said plurality of light emitting diodes emits light to be received by only a different group of optical fibers.

11. The optical fiber light source for a flower display in a vase of claim 8 wherein each of said plurality of light emitting diodes emit light having a color, and said plurality of light emitting diodes emit light of at least two different colors.

12. The optical fiber light source for a flower display in a vase of claim 1 wherein said at least one optical fiber is colored to illuminate said at least one flower with colored light.

13. The optical fiber light source for a flower display in a vase of claim 1 further comprising:
a colored filter positioned between said light source and said at least one optical fiber to color said light emitted by said light source received by said proximal end of said at least one optical fiber to illuminate said at least one flower with colored light.

14. An optical fiber light source for a flower display in a vase comprising:
a vase having an open end and a closed end, said closed end forming a chamber;
at least one flower at least partially in said chamber of said vase, said at least one flower having petals and a stem;
a housing in said chamber in said vase having
a power source;
a light source driven by said power source to emit light; and
at least one optical fiber extending from said housing to adjacent to or among said petals of said at least one flower, said at least one optical fiber having a distal end and a proximal end, said proximal end receiving light emitted by said light source, said optical fiber transmitting said light and said distal end emitting said light to illuminate said at least one flower.

15. The optical fiber light source for a flower display in a vase of claim 14 further comprising:
a switch to turn said light source off and on; and
wherein said light source is at least one light emitting diode.

16. The optical fiber light source for a flower display in a vase of claim 14 wherein said chamber retains water, said stem of said at least one flower being in said water in said chamber in said vase, said housing being waterproof, and said housing being partially submerged in said water in said chamber in said vase.

17. The optical fiber light source for a flower display in a vase of claim 16 further comprising:
a switch to turn said light source off and on; and
wherein said light source is at least one light emitting diode.
